(19) United States
(12) Patent Application Publication
(10) Pub. No.: US 2025/0289128 A1
(43) Pub. Date: Sep. 18, 2025

(54) Control Device And Display Device

(71) Applicant: SEIKO EPSON CORPORATION, Tokyo (JP)

(72) Inventor: Eiji KOBAYASHI, Matsumoto (JP)

(21) Appl. No.: 19/076,212

(22) Filed: Mar. 11, 2025

(30) Foreign Application Priority Data
Mar. 12, 2024 (JP) 2024-037844

(51) Int. Cl. B25J 9/16; B25J 9/00; B25J 18/00; B25J 19/02

(52) U.S. Cl. CPC B25J 9/1653; B25J 9/009; B25J 18/007; B25J 19/02

(57) ABSTRACT

A control device includes an acquisition section configured to acquire chronological operation information of a robot arm to which a plurality of arms are rotatably coupled; a determination section configured to determine, when an error occurs in the operation of the robot arm, a type of the error based on the operation information; and a display control section configured to control a display section to display chronological change information in actual measured values of the operation information corresponding to the type of error determined by the determination section based on error information in which the operation information and the type of error are associated with each other.

The present application is based on, and claims priority from JP Application Serial Number 2024-037844, filed Mar. 12, 2024, the disclosure of which is hereby incorporated by reference herein in its entirety.

### BACKGROUND

### 1. Technical Field

The present disclosure relates to a control device and a display device.

### 2. Related Art

In recent years, in a factory, due to a steep rise in labor cost and a shortage of human resources, operations such as conveyance, manufacturing, processing, assembly, and inspection of a workpiece such as a machine part are performed by a robot with a robot arm, and automation of operations which have been manually performed is progressing. In such a robot, an error may occur during the operation of the robot arm. There are various types of errors, such as an abnormality in the speed of each part of the robot, an abnormality in the position, and an abnormality in the torque outputted. In JP-A-2021-091078, a display device for notifying an operator of the occurrence of an error is disclosed. The display device displays various graph information and the like related to current values, positions, speeds, accelerations, position deviations, speed deviations, and acceleration deviations of the electric motors of the respective parts of the robot at the time when the error occurred. However, in the display device of JP-A-2021-091078, various kinds of information as described above are merely displayed, and there is a problem that it is difficult to intuitively grasp what kind of error has occurred.

### SUMMARY

A control device according to the present disclosure includes:
an acquisition section configured to acquire chronological operation information of a robot arm to which a plurality of arms are rotatably coupled;
a determination section configured to determine, when an error occurs in the operation of the robot arm, a type of the error based on the operation information; and
a display control section configured to control a display section to display chronological change information in actual measured values of the operation information corresponding to the type of error determined by the determination section based on error information in which the operation information and the type of error are associated with each other.

A display device according to the present disclosure is controlled by a control device, the control device having an acquisition section configured to acquire chronological operation information of a robot arm to which the plurality of arms are rotatably coupled, and a determination section configured to determine, when an error occurs in the operation of the robot arm, a type of the error based on the operation information, the display device including
a display section and
a display control section configured to control the display section to display chronological change information in the actual measured values of the operation information corresponding to the type of error determined by the determination section based on error information in which the operation information and the type of error are associated with each other.

### BRIEF DESCRIPTION OF THE DRAWINGS

FIG. 1 is a schematic configuration diagram of a robot system including a control device according to the disclosure.

FIG. 2 is a block diagram of the robot system shown in FIG. 1.

FIG. 3 is an image showing an example of a notification image displayed on the display section shown in FIG. 1.

FIG. 4 is a table illustrating an example of error information in which operation information and a type of error are associated with each other.

FIG. 5 is a table illustrating an example of data for creating a graph indicating the chronological change information in an actual measurement value of operation information.

### DESCRIPTION OF EMBODIMENT

### Embodiment

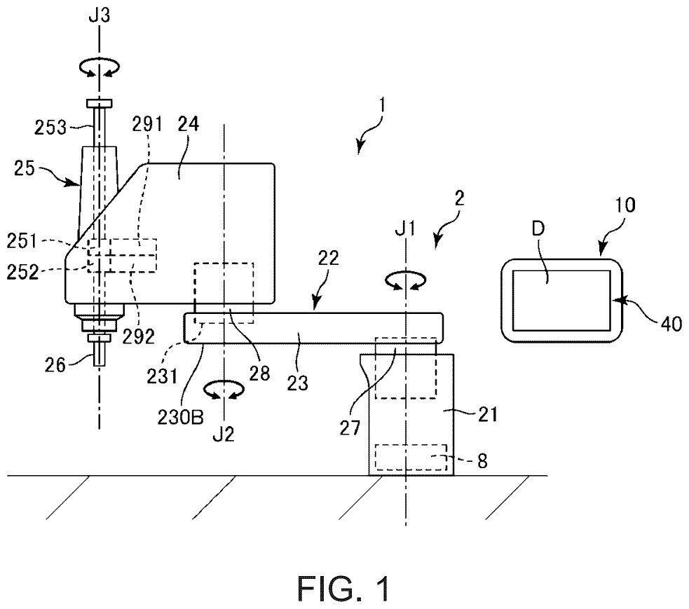

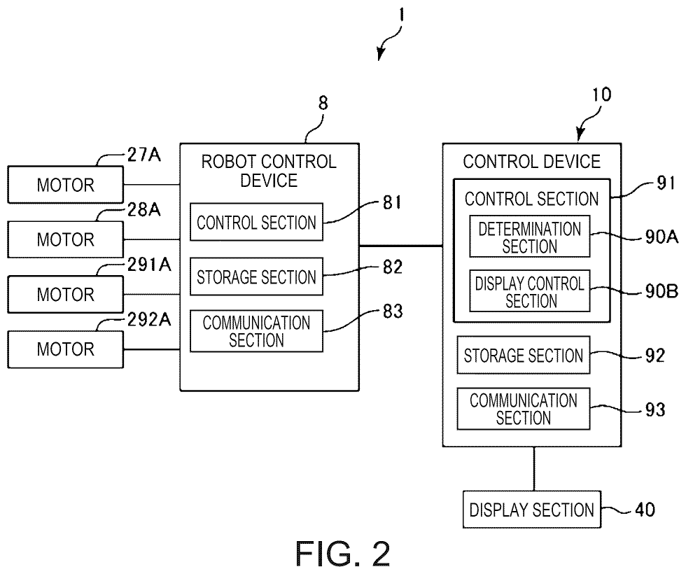

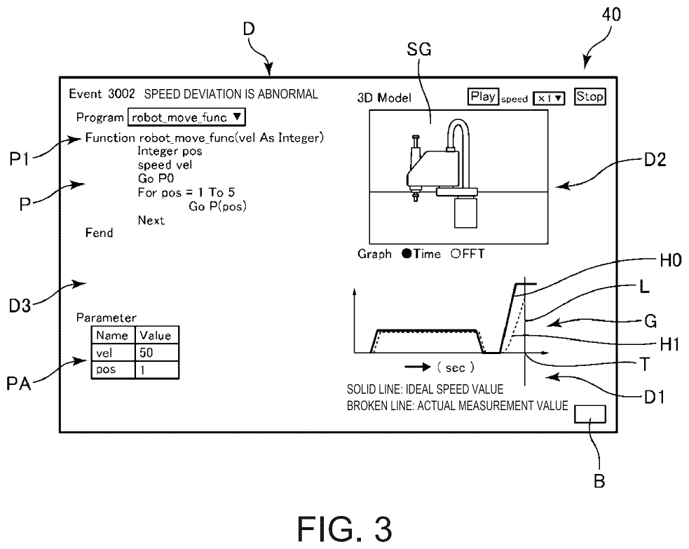

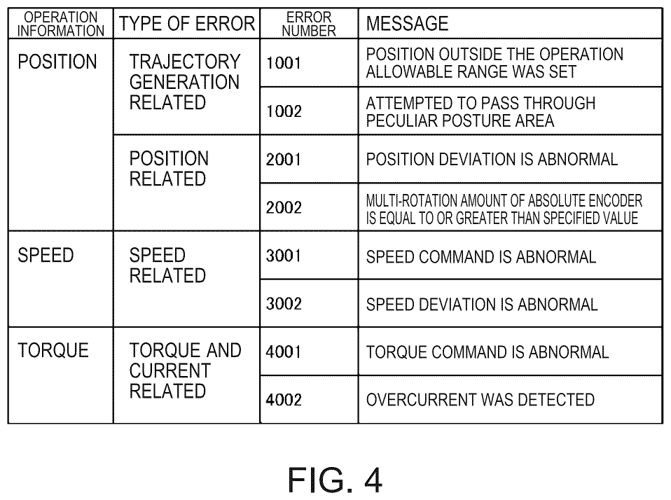

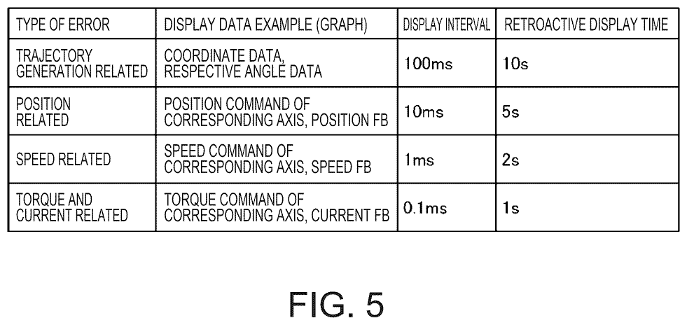

FIG. 1 is a schematic configuration diagram of a robot system including a control device according to the disclosure. FIG. 2 is a block diagram of the robot system shown in FIG. 1. FIG. 3 is an image showing an example of a notification image displayed on the display section shown in FIG. 1. FIG. 4 is a diagram illustrating an example of error information in which operation information and a type of error are associated with each other. FIG. 5 is a diagram illustrating an example of data for creating a graph indicating the chronological change information in an actual measurement value of operation information.

Hereinafter, a control device and a display device according to the present disclosure will be described in detail based on an exemplary embodiment shown in the accompanying drawings.

Hereinafter, for convenience of description, in the robot arm, a base 21 side in FIG. 1 is also referred to as a “proximal end” and the opposite side, that is, an end effector 26 side is also referred to as a “distal end”.

As illustrated in FIG. 1, a robot system 1 includes a robot 2, a robot control device 8 that controls the robot 2, and a control device (display section control device) 10 according to the present disclosure.

First, the robot 2 will be described.

The robot system 1 illustrated in FIG. 1 includes the robot 2, the robot control device 8 that controls driving of the robot 2, and a control device 10.

The robot 2 in the illustrated robot system 1 is a SCARA robot and drives a robot arm 22 by a desired operation. For example, the robot 2 can perform an operation such as transport, assembly, and inspection of a workpiece such as an electronic component, or an operation such as various kinds of processing and coating on a workpiece using a tool (hereinafter, these are collectively simply referred to as “operation”). However, the use of the robot 2 is not particularly limited. The robot 2 according to the present disclosure may be, for example, a six axis articulated robot, an orthogonal robot in which linear sliders are combined, a dual-arm robot, or the like, other than the SCARA robot.

As shown in FIG. 1, the robot 2 includes the base 21 as a base section, and the robot arm 22 rotatably coupled to the base 21. The base 21 is fixed to a floor surface parallel to a horizontal plane.

The robot arm 22 includes a first arm 23 whose base end section is coupled to the base 21 and that rotates with respect to the base 21 about a first rotation axis J1, which is along the vertical direction, and a second arm 24 whose base end section is coupled to the distal end section of the first arm 23 and which rotates with respect to the first arm 23 around a second rotation axis J2, which is along the vertical direction.

A working head 25 is provided at the distal end section of the second arm 24. The working head 25 includes a spline nut 251 and a ball screw nut 252 that are coaxially arranged at the distal end section of the second arm 24, and a spline shaft 253 that is inserted through the spline nut 251 and the ball screw nut 252. The spline shaft 253 is rotatable relative to the second arm 24 about the third rotation axis J3 and is movable up and down along the third rotation axis J3. The third rotation axis J3 is a central axis of the spline shaft 253 and extends along the vertical direction.

The end effector 26 is mounted on a lower end portion of the spline shaft 253. As the end effector 26, a detachable end effector suitable for a target operation is appropriately selected. Examples of the end effector 26 include an end effector capable of holding a workpiece or a tool.

The robot 2 includes a first articulation actuator 27 that couples the base 21 and the first arm 23 and that rotates the first arm 23 around the first rotation axis J1 with respect to the base 21, and a second articulation actuator 28 that couples the first arm 23 and the second arm 24 and that rotate the second arm 24 around the second rotation axis J2 with respect to the first arm 23.

The robot 2 includes a first drive mechanism 291 that rotates the spline nut 251 to rotate the spline shaft 253 around the third rotation axis J3, and a second drive mechanism 292 that rotates the ball screw nut 252 to move the spline shaft 253 up and down in a direction along the third rotation axis J3.

The first articulation actuator 27 includes a motor 27A as a first motor, a decelerator (not shown), an encoder (not shown), and the like. The second articulation actuator 28 includes a motor 28A as a second motor, a decelerator (not shown), an encoder (not shown), and the like. The first drive mechanism 291 includes a motor 291A, a decelerator (not shown), an encoder (not shown), and the like. The second drive mechanism 292 includes a motor 292A, a decelerator (not shown), an encoder (not shown), and the like.

As shown in FIG. 2, each of the motor 27A, the motor 28A, the motor 291A, and the motor 292A is electrically coupled to the robot control device 8 via a motor driver (not shown). The robot control device 8 controls energization conditions, that is, an energization amount, an energization timing, and the like from a power source (not shown) to each the motor 27A, the motor 28A, the motor 291A, and the motor 292A via each motor driver. By this, it is possible to control the operation of the robot arm 22 so as to change each arm to a desired posture.

Each encoder is electrically coupled to the robot control device 8. Each encoder detects rotational position information of the corresponding motor and transmits this information to the robot control device 8. The robot control device 8 controls energization conditions to the motor 27A, the motor 28A, the motor 291A, and the motor 292A based on the rotational position information of each motor received from each encoder. It is possible to accurately perform a desired operation by controlling the operation of the robot arm 22 while grasping the rotational positions of each motor 27A, the motor 28A, the motor 291A, and the motor 292A.

As shown in FIG. 1, the robot control device 8 is built in the base 21 in present embodiment. However, the present disclosure is not limited to this configuration, and the robot control device 8 may be installed at a position away from the robot 2. The robot control device 8 has a function of controlling the driving of the robot 2 and is electrically coupled to each unit of the robot 2 described above. As shown in FIG. 2, the robot control device 8 includes a control section 81, a storage section 82, and a communication section 83. These sections are communicably coupled to each other via, for example, a bus.

The control section 81 is constituted by, for example, a central processing unit (CPU), and reads and executes various programs such as the operation program P stored in the storage section 82. Signals generated by the control section 81 are transmitted to each section of the robot 2 via the communication section 83, and signals from each section of the robot 2 are received by the control section 81 via the communication section 83. By this, the robot arm 22 can execute a predetermined operation under a predetermined condition.

The storage section 82 stores various programs and the like executed by the control section 81. As the storage section 82, for example, a storage unit having a configuration including a volatile memory such as a random access memory (RAM), a nonvolatile memory such as a read only memory (ROM), a detachable external storage device, or the like is exemplified.

The communication section 83 transmits and receives a signal to and from each section of the robot 2 using an external interface such as a wired local area network (LAN) or a wireless LAN. In this case, communication may be performed via a server (not shown), or via a network such as the Internet.

Next, the control device 10 of the present disclosure will be described.

As shown in FIGS. 1 and 2, the control device 10 is a display section control device that controls the operation of a display section 40. In the present embodiment, the control device 10 is a tablet terminal built into a device main body having the display section 40. However, the present disclosure is not limited to this configuration, and the control device 10 may be built into a laptop computer, a desktop personal computer, a teaching pendant, a smartphone, or the like. The control device 10 may be built into or integrated with the above-described robot control device 8 or may be configured as a part of the robot control device 8.

The display section 40 is a display including a touch panel. An operator (user) views an image displayed on the display section 40 or performs a desired touch operation (hereinafter, simply referred to as an “operation”) with his/her finger or a touch pen to input the various kinds of information.

The display section 40 is formed of, for example, liquid crystal, organic EL, or the like, and has, for example, an operation function (input function) by touch operation in addition to an information display function. The display section 40 can display a display screen and an operation screen in color or monochrome. The touch panel type in the display section 40 may be a pressure-sensitive type or a capacitive type.

The control device 10 includes a control section 91, a storage section 92, and a communication section 93. These are installed in the device main body.

The control section 91 is formed of, for example, at least one processor such as a central processing unit (CPU) and reads and executes various programs such as a teaching program stored in the storage section 92. The control section 91 has functions of determining whether or not an error has occurred in the robot 2, determining the type of error, controlling the operation of the display section 40, and the like.

Among the processors included in the control section 91, a processor that determines whether or not an error has occurred in the robot 2 and determines the type of error is a determination section 90A. Among the processors included in the control section 91, the processor that controls the operation of the display section 40 is a display control section 90B. These functions will be described in detail later.

The storage section 92 stores various programs and the like executable by the control section 91. As the storage section 92, for example, a storage unit having a configuration including a volatile memory such as a random access memory (RAM), a nonvolatile memory such as a read only memory (ROM), a detachable external storage device, or the like is exemplified.

The communication section 93 transmits and receives a signal to and from the display section 40 or an external device such as the robot control device 8 by wired or wireless, for example, using such as an external interface such as a wired local area network (LAN) or a wireless LAN. In this case, communication may be performed via a server (not shown), or via a network such as the Internet.

The communication section 93 functions as an acquisition section that acquires information indicating a plurality of types of chronological changes related to the operation of each section of the robot arm 22. In other words, the acquisition section acquires the chronological operation information of the robot arm 22. The communication section 93 acquires chronological operation information of the robot arm 22 via the robot control device 8. The chronological operation information mentioned here is information that changes with the passage of time. In other words, it is information in which a numerical value or data acquired by the communication section 93 changes by activating the robot or driving the robot arm 22. The operation information includes, for example, information about the speed of each part of the robot arm 22, information about the pose of each part of the robot arm 22, and information about the torque of each part of the robot arm 22. In addition, the operation information may include other information.

The information on the speed of each part of the robot arm 22 includes at least one, or in the case of the present embodiment all, of the following types of information: the rotation speed of the first arm 23 with respect to the base 21; the rotation speed of the second arm 24 with respect to the first arm 23; the rotation speed of the working head 25; the raising and lowering speed of the working head 25; the acceleration of the first arm 23 in the rotation direction with respect to the base 21; the acceleration of the second arm 24 in the rotation direction with respect to the first arm 23; the acceleration of the working head 25 in the rotation direction; and the acceleration of the working head 25 during raising and lowering. This information can be obtained based on, for example, encoder values of encoders coupled to the motor 27A, the motor 28A, the motor 291A, and the motor 292A, and values outputted from sensors, such as a speed sensor and an acceleration sensor.

The information on the pose of each part of the robot arm 22 is information on the rotational position of the first arm 23 with respect to the base 21, the rotational position of the second arm 24 with respect to the first arm 23, the rotational position of the working head 25, and the raising and lowering position of the working head 25. This position information can be obtained, for example, based on encoder values of the encoders coupled to each motor 27A, the motor 28A, the motor 291A, and the motor 292A.

The information regarding the torque of each part of the robot arm 22 is information regarding the output torque of the first articulation actuator 27, the second articulation actuator 28, the first drive mechanism 291, and the second drive mechanism 292. The information on the outputted torque can be obtained based on, for example, the current values of the motor 27A, the motor 28A, the motor 291A, and the motor 292A, and the outputted value of a torque sensor (not shown).

The communication section 93 acquires these pieces of information chronologically. The acquired information is stored in the storage section 92 at any time.

Here, an error may occur in the operation of each part of the robot arm 22 during the operation of the robot arm 22. As the error, for example, there are various types such as a speed abnormality, a torque abnormality, a pose abnormality, and collision with another object. When such an error occurs in the robot 2, the control device 10 causes the display section 40 to display a notification screen D as shown in FIG. 3. Hereinafter, the notification screen D will be described.

In the control device 10, the communication section 93, functioning as an acquisition section, acquires the chronological operation information of the robot arm 22 during the operation of the robot arm 22. In other words, the communication section 93 acquires the above-described operation information chronologically during the operation of the robot arm 22. “Acquiring the operation information chronologically” includes a configuration in which the operation information is constantly acquired, a configuration in which the operation information is constantly acquired at predetermined intervals (for example, 1 ms), and the like.

Then, the determination section 90A determines whether or not an error has occurred in the operation of the robot arm 22 based on the chronological operation information of the robot arm 22 and determines the type of the error based on the operation information at the time when the error occurred in the operation of the robot arm 22.

The determination of whether or not an error occurred in the operation of the robot arm 22 is performed based on, for example: (determination 1) whether the obtained speed deviates by a predetermined value or more in each piece of information included in the information relating to the speed of each part of the robot arm 22; (determination 2) whether the obtained position information deviates by a predetermined value or more in each piece of position information included in the information relating to the pose information of each part of the robot arm 22; (determination 3) whether the obtained torque deviates by a predetermined value or more in the information included in the information relating to the torque of each part of the robot arm 22.

In the present embodiment, these three determinations are performed, but one or two of these determinations may be performed. Other determinations may also be made.

In a case where it is determined that an error occurred in the operation of the robot arm 22, the determination section 90A determines the type of the error based on the operation information. In other words, the type of error is determined based on which of the determinations 1, 2, and 3 determines that an error has occurred. For example, when it is determined as an error in the determination 1, it is determined that there is an abnormality in the speed of each part of the robot arm 22. An occurrence of error may be determined by only one type of the three types of determinations, or an occurrence of error may be determined by two types or three types of determinations.

The display control section 90B generates the notification screen D based on the error information illustrated in FIG. 4 and controls the operation of the display section 40 so as to display the notification screen D on the display section 40.

As illustrated in FIG. 4, the error information is information in which the operation information and the type of error are associated with each other and is stored in the storage section 82 as a table, for example. The error information may be stored in a storage device other than the storage section 82.

In the example illustrated in FIG. 4, the error information is stored by associating, with respect to the operation information of “position”, “speed”, and “torque”, the type of error (“trajectory generation related”, “position related”, “speed related”, and “torque and current related”), an error number, and a message to be displayed.

The items of “trajectory generation related” and “position related” are items related to the position of each part of the robot arm 22, the item of “speed related” is an item related to the speed information of the robot arm 22, and the items of “torque and current related” are items related to the torque information of the robot arm 22.

Based on such error information, the display control section 90B generates the following notification screen D and displays the notification screen D on the display section 40.

As shown in FIG. 3, the notification screen D includes a first region D1 in which a graph G is displayed, a second region D2 in which a simulation image SG of the robot 2 is displayed, and a third region D3 in which an operation program P is displayed. The first region D1 is located on the lower right in FIG. 3, the second region D2 is located above the first region D1 in FIG. 3, and the third region D3 is located to the left side of the first region D1 and the second region D2 in FIG. 3.

In the present embodiment, the display positions of the first region D1, the second region D2, and the third region D3 on the notification screen D are such that the first region D1 is at the lower right side in FIG. 3, the second region D2 is at the upper right side in FIG. 3, and the third region D3 is at the left side in FIG. 3, but the present disclosure is not limited to such an arrangement.

In the notification screen D, the first region D1, the second region D2, and the third region D3 are simultaneously displayed in one window, but the present disclosure is not limited to this, and the first region D1, the second region D2, and the third region D3 may be displayed in one window at any time, particularly in a predetermined order, or may be selectively displayed.

In a case where the first region D1, the second region D2, and the third region D3 are selectively displayed on the notification screen D, selection buttons (not illustrated) for selecting these areas may be provided on the notification screen D.

Further, the first region D1, the second region D2, and the third region D3 may be displayed in different windows. In this case, each window may be operated to be enlarged, reduced, moved, or the like.

As illustrated in FIG. 3, a graph G is displayed in the first region D1. In the graph G, the horizontal axis represents the time T, and the vertical axis represents the operation information. In the illustrated example, the vertical axis represents the actual measured values H1 of the rotation speed of the portion where the error occurred. In other words, the graph G indicates chronological changes of the operation information. One type of graph G is displayed in the first region D1 but two or more types of graphs G may be separately displayed simultaneously, two or more types of graphs G may be displayed in an overlapping manner, or two or more types of graphs G may be displayed at any time or selectively.

In the graph G, the actual measurement value at the time at which the error occurred is displayed in an emphasized manner. In other words, on the graph G, the position where the actual measurement H1 value at the time of the occurrence of the error was plotted is emphasized. In the illustrated example, in the graph G, a vertical straight line L is displayed at the position where the error occurred, that is, at the time T. By this, the actual measured values H1 at the time of occurrence of an error can be grasped immediately. Note that the line is not limited to a straight line, and the portion where an error occurred may be surrounded by a square or a circle or may be colored.

Since the chronological changes of the actual measured values H1 of the operation information related to the error can be immediately grasped, the degree of abnormality of the operation information can be immediately grasped.

In the graph G, in addition to the actual measured values H1, the speed command value, that is, the ideal value H0 is displayed chronologically. By this, it is possible to clearly grasp how much the actual measured values H1 deviate from the ideal value H0 when an error occurs.

Although not shown, depending on the type of error, the actual measurement value of the acceleration or torque of each part of the robot arm 22 may be displayed on the vertical axis. Various kinds of errors may be displayed in the graph G collectively or at any time.

In the first region D1, for example, a switching button B for switching between a mode in which the horizontal axis is displayed by time and a mode in which the horizontal axis is displayed by frequencies is displayed. In other words, the types and units of the horizontal axis and the vertical axis of the graph G to be displayed can be switched by the operation of the switching button B. By this, it is possible to appropriately switch to a graph G of a type that is easily understood by the operator, a graph G of a type desired by the operator, or the like in accordance with the type of the operation information related to the error.

In the present embodiment, the switching button B is displayed on the lower right side of the graph G in the first region D1 in FIG. 3, but the display position of the switching button B is not limited to this.

In this way, by displaying the graph G, which is the chronological changes of the actual measured values H1 of the operation information related to the error according to the type of the error, the operator can immediately grasp the chronological changes of the actual measured values H1 of the operation information related to the error when the error occurs. Therefore, it is possible to appropriately and quickly perform subsequent measures, for example, correction of the operation program P, removal of the obstacle, maintenance of the robot arm 22, and the like. In the present embodiment, the information having low relevance to the content of the error that has occurred is not displayed on the display section 40 as in the related art. In other words, in the present embodiment, not all of the plurality of types of operation information acquired by the acquisition section are displayed. Therefore, since the operator can preferentially check the information that is highly likely to be the cause of the error, the error can be quickly corrected.

The graph G is generated, for example, based on data as illustrated in FIG. 5. The data illustrated in FIG. 5 is data in which the type of error, the display data example, the display interval (the interval of the scale mark on the horizontal axis of the graph G), and the retroactive display time are stored in association with each other. The display control section 90B displays a graph corresponding to the type of error in the first region D1. At that time, the graph is displayed at a display interval corresponding to the graph to be displayed, and at a retroactive display time. When the operator operates the switch button B to select another graph, the graph is displayed with the display interval and the retroactive display time corresponding to the selected graph. Note that the display interval and the retroactive display time are not limited to the values shown in FIG. 5. Alternatively, it may be set by the operator.

As shown in FIG. 3, a simulation image SG of the robot 2 is displayed in the second region D2. In the present embodiment, the simulation image SG is a three dimensional image of the robot (3D Model).

The robot 2 in the simulation image SG is displayed in the posture at the time when the error occurred. By this, it is possible to grasp at a glance in what the posture was when an error occurred.

In addition, although not illustrated, a type of error or a portion where the error occurred may be displayed in the simulation image SG.

The simulation image SG may be a still image, a moving image, or a configuration in which a still image and a moving image are switched and displayed by an arbitrary operation. In the simulation image SG that is the moving image, by operating buttons such as “Play”, “Stop”, and “Speed” displayed in the upper part of the second region D2 in FIG. 3, the moving image can be played back, stopped, and the playback speed can be set.

When the simulation image SG is displayed as a moving image, the posture before and after the occurrence of the error can also be grasped, and the error can be grasped more accurately.

As shown in FIG. 3, a robot program, that is, an operation program P is displayed in a robot language in the third region D3. However, it is not limited to this configuration, and may be displayed in another language, for example, in C language.

The operation program P is constituted by a set of unit operation programs P1, and the operation program P including the unit operation programs P1 related to the error is displayed in the third region D3. In the illustrated configuration, the item “robot_move_func” is displayed, and the character string “Go P (pos)”, which is the location where the error occurred, is displayed in bold and in a color different from the surroundings. With such a configuration, it is possible to immediately grasp which unit operation program P1 is being executed when an error occurs.

The parameter PA set in the operation program P is displayed in the third region D3. To be more specific, the word “Parameter” is displayed below the operation program P in FIG. 3, and a table is displayed below the word. For “vel”, 50 is set, and for “pos”, 1 is set. “Vel” and “pos” are variables used in the operation program P, and it is possible to grasp how these numerical values are set. In addition, it is possible to easily grasp the appropriateness of the parameter PA and how to correct the parameter PA by grasping the degree of the error in the graph G and confirming the parameter PA.

Further, the word “Event” is displayed in the upper portion of the third region D3 in FIG. 3, and characters “3002 Speed deviation is abnormal” are displayed on the right side thereof. In other words, the error number and the type of error are displayed.

As described above, these characters are selected and displayed by a display control section 40B with reference to the error information shown in FIG. 4.

In the present disclosure, the existence of the second region D2 is not necessary. In other words, the simulation image SG may not be displayed on the notification screen D. Further, in the present disclosure, the existence of the third region D3 is not necessary. In other words, the operation program P or the parameter PA may not be displayed on the notification screen D.

As described above, the control device 10 includes the communication section 93 as an acquisition section for acquiring chronological operation information of the robot arm 22, which is rotatably coupled to the first arm 23, to the second arm 24, and to the working head 25, the determination section 90A configured to determine the type of error based on the operation information when an error occurs in the operation of the robot arm 22, and the display control section 90B configured to control the display section 40 to display chronological change information in actual measured values H1 of the operation information corresponding to the type of error determined by the determination section 90A based on error information in which the operation information and type of error are associated. By this, since the operation information to be displayed is changed according to the type of error, when an error occurs, the operator can immediately grasp the chronological changes of the actual measured values H1 of the operation information related to the error. Therefore, since display of display data the display section 40 having low relevance to the error is suppressed, the operator can preferentially check the necessary operation information and accurately and quickly take subsequent measures.

Note that the case has been described in which the graph G is displayed as an example of the chronological change information in the actual measured values H1 of the operation information, but the present disclosure is not limited to this, and the information may be displayed in another format such as a bar graph or a pie graph.

Note that the chronological change information in the actual measured values H1 of the operation information is not limited to the graph G and may be a table or the like in which the actual measurement values are indicated by numbers chronologically.

The operation information is at least one of speed, acceleration, and torque of the first arm 23, the second arm 24, which are the arms of the robot arm 22, and the working head 25. The speed, acceleration, and torque of the arm are important items, and are items in which errors occur frequently. By acquiring and displaying the information of the actual measured values H1 of these items chronologically, the operator can grasp the contents of the error or the like specifically or in more detail.

In the present disclosure, the operation information may include information on items other than the above three types and other information. In addition, the operation information may be any one or two of the above three types of information.

The chronological change information is a graph G in which the horizontal axis represents time, and the vertical axis represents the actual measured values H1. By this, when an error occurs, it is possible to more intuitively grasp the chronological changes of the actual measured values H1 of the operation information related to the error.

The display control section 90B controls the display section 40 to display the actual measured values H1 of the time at which the error occurred in the graph G in an emphasized manner. By this, in the displayed graph G, the position where the error occurred can be grasped more quickly.

The display control section 90B controls the display section 40 to display the operation program P including the unit operation program P1 related to the error. By this, the operator can grasp the unit operation program P1 related to the error. As a result, the appropriateness of the program can be easily determined, and the program can be appropriately corrected.

The display control section 90B controls the display section 40 to emphasize display the unit operation program P1 related to the error. By this, the operator can more accurately grasp the unit operation program P1 related to the error. As a result, the appropriateness of the unit operation program P1 in the operation program P can be easily determined, and the unit operation program P1 or the unit operation programs P1 that is executed before and after the unit operation program P1 can be appropriately corrected.

Further, the robot system 1 may include a display device such as a teaching pendant and the control device 10. In this case, the display device is controlled by the control device 10 and includes the display section 40 and the display control section 90B. The display control section 90B controls the display section 40 to display the chronological change information of the actual measured values H1 of the operation information corresponding to the type of the error determined by the determination section 90A on the display section 40 based on the error information in which the operation information and the type of the error are associated with each other. By this, since the operation information to be displayed is changed according to the type of error, when an error occurs, the operator can immediately grasp the chronological changes of the actual measured values H1 of the operation information related to the error. Since display of data on the display section 40 having low relevance to an error is suppressed, the operator can preferentially check the necessary operation information and accurately and quickly take subsequent measures.

As described above, the display device is controlled by the control device 10, which includes the communication section 93 and the determination section 90A. The communication section 93 functions as an acquisition section to acquire chronological operation information of the robot arm 22, which is rotatably coupled to the first arm 23, the second arm 24, and the working head 25. The determination section 90A determines the type of error based on the operation information when an error occurs in the operation of the robot arm 22. The display device includes the display section 40 and the display control section 90B, which controls the display section 40 to display on the display section 40 the chronological change information in the actual measured values H1 of the operation information that corresponds to the type of error determined by the determination section 90A, based on the error information in which the operation information and the type of error are associated with each other. By this, since the operation information to be displayed is changed according to the type of error, when an error occurs, the operator can immediately grasp the chronological changes of the actual measured values H1 of the operation information related to the error. Since display of data on the display section 40 having low relevance to an error is suppressed, the operator can preferentially check the necessary operation information and accurately and quickly take subsequent measures.

The control device 10 of the present disclosure may be built into a device main body having the display section 40 or may include the display section 40. In these cases, the control device 10 of the present disclosure can be regarded as a display device. Further, the control device 10 is not limited to being integrated with the display section 40. The control device 10 and the display section 40 may be separate bodies. In this case, the display section 40 can be referred to as a display device.

Although the control device and the display device of the present disclosure have been described with reference to the embodiments shown in the drawings, the present disclosure is not limited to this. Each section of the control device and the display device can be replaced with an arbitrary component or the like which can exhibit the same function. Further, an arbitrary component or the like may be added.

What is claimed is:

1. A control device comprising:
an acquisition section configured to acquire chronological operation information of a robot arm to which a plurality of arms is rotatably coupled;
a determination section configured to determine, when an error occurs in the operation of the robot arm, a type of the error based on the operation information; and
a display control section configured to control a display section to display chronological change information in actual measured values of the operation information corresponding to the type of error determined by the determination section based on error information in which the operation information and the type of error are associated with each other.

2. The control device according to claim 1, wherein
the operation information includes at least one of speed, acceleration, or torque of the robot arm.

3. The control device according to claim 1, wherein
the chronological change information is represented as a graph where the horizontal axis represents time, and the vertical axis represents the actual measurement value.

4. The control device according to claim 3, wherein
the display control section controls the display section to emphasize on the graph the actual measurement value from when the error occurred.

5. The control device according to claim 1, wherein
the display control section controls the display section to display an operation program including a unit operation program related to the error.

6. The control device according to claim 5, wherein
the display control section controls the display section to emphasize display of the unit operation program related to the error.

7. A display device controlled by a control device, the control device including an acquisition section configured to acquire chronological operation information of a robot arm to which a plurality of arms are rotatably coupled, and a determination section configured to determine, when an error occurs in the operation of the robot arm, a type of the error based on the operation information, the display device comprising:
a display section and
a display control section configured to control the display section to display chronological change information in the actual measured values of the operation information corresponding to the type of error determined by the determination section based on error information in which the operation information and the type of error are associated with each other.
